(19) United States
(12) Patent Application Publication
(10) Pub. No.: US 2008/0246892 A1
(43) Pub. Date: Oct. 9, 2008

(54) PROJECTION SCREEN

(75) Inventor: Chun-Tang Lee, Jiangsu Province (CN)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NANO PRECISION (SUZHOU) CO., LTD, Jiangsu Province (CN)

(21) Appl. No.: 11/946,823

(22) Filed: Nov. 28, 2007

(30) Foreign Application Priority Data
Apr. 6, 2007 (CN) 200720036320.8

(51) Int. Cl. H04N 5/64

(52) U.S. Cl. 348/744; 348/E05.128

(57) ABSTRACT

A projection screen is provided, which includes a casing having an opening disposed at the bottom thereof. The casing at least has two shafts, two screens, two stay tubes, and two driving devices disposed therein. Each of the shafts has a screen wound thereon, each screen correspondingly has a stay tube disposed at the bottom thereof, and each driving device drives a shaft. The shafts are disposed inside the casing and a screen of one material is wound on each shaft, thus the match between the projection screen and various projectors is realized by the alternation of the screens to adapt to various projection circumstances and contents, so as to obtain a better optimal projection effect.

### CROSS-REFERENCE TO RELATED APPLICATION

This application claims the priority benefit of China application serial no. 200720036320.8, filed on Apr. 6, 2007. The entirety of the above-mentioned patent application is hereby incorporated by reference herein and made a part of this specification.

### BACKGROUND OF THE INVENTION

1. Field of the Invention

The present invention relates to a projection screen. More particularly, the present invention relates to a projection screen for a projector.

2. Description of Related Art

Projection devices are used to project images on a projection screen for amplifying and displaying images for presentation, propaganda, and teaching. The screen of the projection screen can be made of various materials with different properties. On one hand, different projectors has different requirements on the screen, and a match problem between the two exists; on the other hand, as the projection circumstances has different lights, the requirements for the absorbency or reflectivity of screen on light are different. Even for the same projector and the same light of projection circumstance, when watching different contents, the requirements for the screens are different, for example, static frames need high frame brightness, and dynamic movies need good frame contrast and color rendering. In order to meet various requirements, the material of the screen should be match with the projector and the projection contents, thereby achieving a better optimal display effect.

The structure of the common electric projection screen includes a casing, a shaft disposed inside the casing, a screen wound on the shaft, a stay tube fixed at the bottom of the screen, and a driving device. The casing has an opening at the bottom thereof, and the common driving device is, for example, disposed on a coaxial electric machine on an end of the shaft. Therefore, the screen of the electric projection screen of the above structure can merely adopt a single material, thereby being not capable of meeting the requirements for various materials corresponding to various projection requirements in actual practice.

In order to solve the problem, US patent No. U.S. Pat. No. 7,042,640B2 set forth a projection screen of various materials, which has a structure including: an integral screen formed by two or more screens of different materials, two shafts disposed in a casing, and respectively connected to two ends of the integral screen, and stay tubes disposed on the joints of the screens of different materials. There are two ways for the projection screen to realize the change between the screens of various materials: (1) disposing a shaft rotating around the vertical direction of the screen center, such that the required projection work surface is turned to the front by driving the screen to rotate around the vertical shaft by an electric machine; (2) disposing a plurality of screens of different materials, such that the screen of suitable material is located in front of the projector by correspondingly rotating two shafts.

However, some disadvantages still exist in the two methods of changing screens in the above structure. For the former method, the screen and the casing are required to integrally rotate around the medial axis of the screen, a rotating space of at least a half of the casing length is required, and thus the projection screen cannot be disposed against a wall when mounting, casing a large floor space. At the same time, it is difficult to integrally rotate the screen and the casing, and the method is merely suitable for the screens of two materials. For the later method, though the space arrangement problem does not exist, the time for switching different screens is long, the screens is a whole having a large weight, thus increasing the load of the driving electric machine, and the part of screen behind the projection screen is wasted, thereby the fabrication cost is greatly increased. Furthermore, when changing the screens of various materials, a problem of changes in the position of the stay tubes still exists, and thus the relative motion of the stay tubes and the screens leads to the damage of the screens.

### SUMMARY OF THE INVENTION

Accordingly, the present invention is directed to providing a projection screen, in which the screens of various materials can be flexibly changed, thereby obtaining excellent projection effect.

As embodied and broadly described herein, the present invention provides a projection screen, which includes a casing having an opening at the bottom thereof. The casing at least has two shafts, two screens, two stay tubes, and two driving devices disposed therein. Each of the shafts has a screen wound thereon, each screen correspondingly has a stay tube disposed at the bottom thereof, and each driving device drives a shaft.

According to an embodiment of the present invention, in the projection screen, the screens wound on different shafts are made of different materials, such as matte white, matte grey, and glass beads. The driving device for driving the shafts to rotate can be a common electric machine. In operation, the rotation of the electric machine is controlled by a control device, so as to select a suitable screen on the basis of the requirements of the used projection and the ambient circumstance. The output of the electric machine rotates the corresponding shaft through a transmission mechanism, the screen falls down and is unwound, and other screens are kept at wound state. The matching of the projection screen and the projector, the projection contents or the ambient circumstances is realized by selecting the screen, so as to obtain the optimal projection effect.

According to an embodiment of the present invention, each of the shafts has a coaxial electric machine disposed at an end thereof, so as to form the driving device. The shafts are driven by individual coaxial electric machines, so that the independent ascent and descent of the individual screens can be conveniently controlled, thereby simplifying the transmission mechanism, and ensuring the coaxiality of the shafts when rotating.

According to an embodiment of the present invention, the shafts can be arranged in a plurality of manners. According to one arrangement, the shafts are horizontally arranged inside the casing in parallel, and the casing has an opening corresponding to the position of each of the screens at the bottom thereof.

According to another preferred arrangement of the shafts, the shafts are longitudinally arranged inside the casing in parallel in two rows, the casing has an opening located between two shafts at the bottom thereof, and the position of each of the screens is arranged corresponding to the opening. In this arrangement, as the positions of different screens are close to each other when the screens are pulled down, it is not necessary to adjust the projection focus of the projectors any more, thereby being more convenient in operation of the projection screen.

Compared with the conventional technique, the projection screen of the present invention has one or more of the following advantages.

1. According to the present invention, as a plurality of shafts are disposed inside the casing, the shafts have screens made of different materials wound thereon respectively, the projection screen can be adapted for the requirements of the projectors, the projection contents and the ambient circumstances by selecting the screen, thereby achieving a better optimal projection effect.

2. In the projection screen according to the present invention, each of the shafts has a screen disposed thereon, so the screens can be wound conveniently, and be alternated rapidly, therefore, the driving device has a low load and is less likely to be damaged.

3. The shafts of the projection screen of the present invention can be arranged in parallel in two rows, the opening for the screen to pass through is located on the center of the casing, and the distances between each screen of the projection screens and the projector are substantially the same, so it is not necessary to adjust the projection focus after the alternation of the screens, thereby being convenient in operation of the projection screen.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic structural view of a first embodiment according to the present invention.

FIG. 2 is a schematic structural view of a second embodiment according to the present invention.

FIG. 3 is a schematic structural view of a third embodiment according to the present invention.

FIG. 4 is a schematic structural view of a fourth embodiment according to the present invention.

### DESCRIPTION OF EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein are meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component facing “B” component directly or one or more additional components is between “A” component and “B” component. Also, the description of “A” component “adjacent to” “B” component herein may contain the situations that “A” component is directly “adjacent to” “B” component or one or more additional components is between “A” component and “B” component. Accordingly, the drawings and descriptions will be regarded as illustrative in nature and not as restrictive.

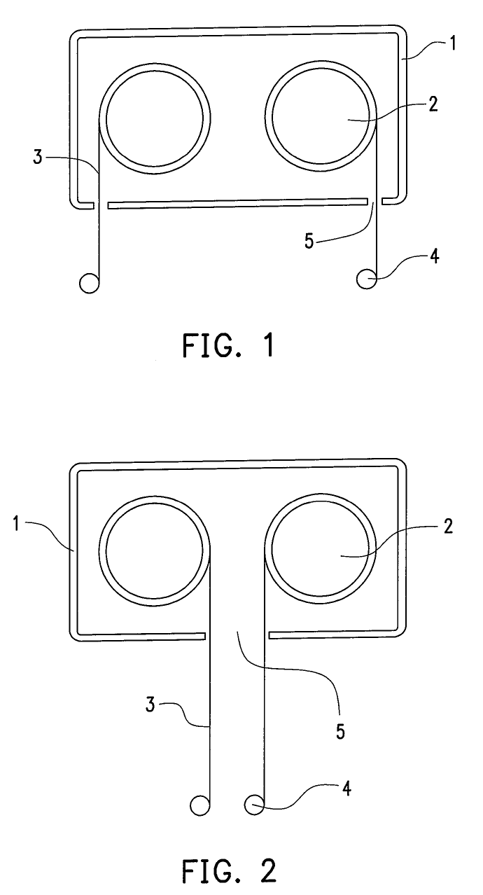

Referring to FIG. 1, a projection screen according to a first embodiment of the present invention includes a casing 1, two shafts 2 disposed inside the casing, two screens 3 respectively wound on each of the shafts 2, and two driving devices respectively disposed in each of the shafts 2, for example, coaxial electric machines (not shown). Each of the screens 3 respectively has a stay tube 4 disposed at the bottom thereof, which is fixed on the screen 3. Each of the shafts 2 is laterally disposed inside the casing 1 in parallel. At the bottom of the casing 1, two parallel arranged openings are corresponding to the two screens 3, respectively. As the connection of the shafts 2 and the casing 1 and the connecting structure of the coaxial electric machines (not shown) and the shafts 2 can adopt the current technique and are not shown in the accompanied drawings. In operation, the screens 3 wound on the shafts 2 are different materials, that is to say, the screens have different microstructures, and thus the corresponding projection properties are different. For example, a matte white screen having a large viewing angle may be wound on the left shaft 2, and a glass beaded screen having high brightness may be wound on the right shaft 2. Each of the coaxial electric machines (not shown) respectively drives a shaft 2, the rotation directions of the coaxial electric machines (not shown) on the shafts 2 are controlled by a remote control device or by directly applying force by a person, for example, when the left shaft 2 is clockwise rotated, the screen is wound up, when the left shaft 2 is counterclockwise rotated, the screen is unwound. On the contrary, when the right shaft 2 is clockwise rotated, the screen is unwound, when the right shaft 2 is counterclockwise rotated, the screen is wound up. The projection screen may be adapted for the requirements of various projectors, various projection circumstances and contents due to the different materials of the screens on the two shafts, so as to obtain the optimal projection effect.

Referring to FIG. 2, as for a projection screen according to a second embodiment of the present invention, the basic structure thereof is similar to that of the first embodiment, and the difference lies in that a casing 1 of the projection screen has an opening 5 located between two shafts 2 at the bottom thereof, the position of each of the screens 3 is disposed corresponding to the opening 5, that is to say, the screens 3 wound on two shafts 2 ascends and descends in the opening 5, and the rotation directions of the two shafts 2 are opposite to that in the first embodiment during ascent and descent. As the distance between two screens 3 is small, in operation, the alternation of the two screens will not have a large influence on the projection focus of the projector, thus twice focusing is avoided.

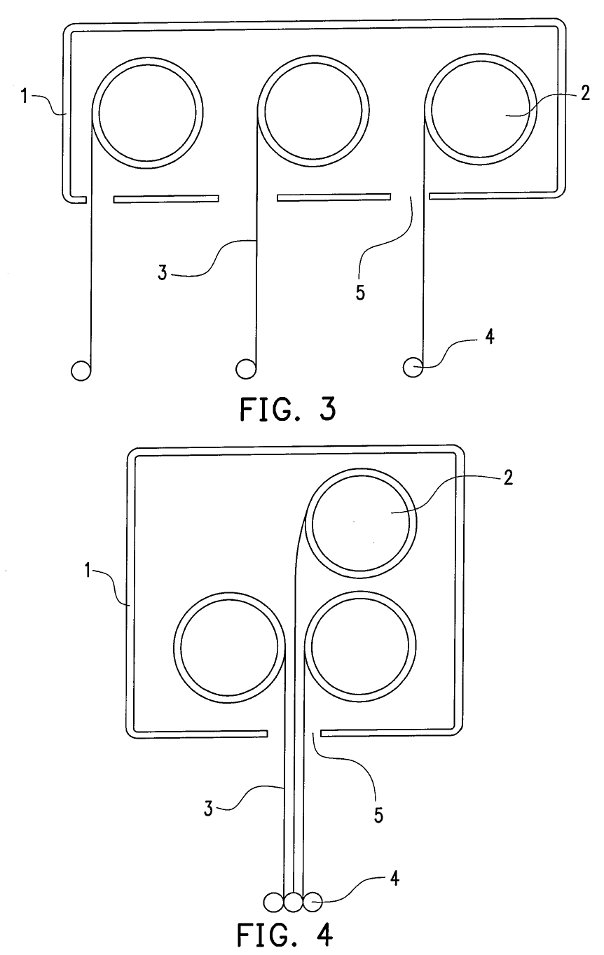

Referring to FIG. 3, a projection screen according to a third embodiment of the present invention includes a casing 1, three shafts 2 disposed inside the casing 1, screens 3 respectively wound on each of the shafts 2, stay tubes 4 correspondingly disposed at the bottom of each of the screens 3 for fixing, and coaxial electric machine driving devices (not shown) disposed on each of the shafts 2, in which the three shafts 2 are laterally arranged inside the casing 1 in parallel, the positions of the three screens are, for example, on the lift side of the corresponding shafts 2, and the casing 1 has an opening 5 disposed corresponding to the position of each of the screens 3 at the bottom thereof.

Referring to FIG. 4, as for a projection screen according to a fourth embodiment of the present invention, the structure thereof is similar to that of the third embodiment, and the difference lies in that the three shafts 2 are longitudinally arranged in a casing 1 in parallel in two rows, the casing 1 has an opening 5 located between two shafts 2 at the bottom thereof, the position of the left screen 3 is located at the right side of the corresponding shaft 2, the position of the right screen 3 is located at the left side of the corresponding shaft 2, and the position of the each of the screen 3 corresponds to the opening 5. By adopting the structure according to this embodiment, on one hand, it is not necessary to focusing generally after the alternation of the screens due to small distance between the screens, on the other hand, structures of more screens can be built, as long as shafts, coaxial electric machines, and corresponding screens are additionally disposed above each row.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A projection screen, comprising:
a casing, having an opening at the bottom thereof;
at least two shafts, disposed inside the casing;
at least two screens, each of the two screens respectively wound on one of the shafts;
at least two stay tubes, each of the two stay tubes respectively fixed at the bottom of one of the screens; and
at least two driving devices, each of the two driving devices respectively disposed in one of the shafts, for respectively driving one of the shafts.

2. The projection screen as claimed in claim 1, wherein the driving devices are coaxial electric machines.

3. The projection screen as claimed in claim 1, wherein the screens has different microstructures.

4. The projection screen as claimed in claim 1, wherein the shafts are horizontally disposed inside the casing in parallel.

5. The projection screen as claimed in claim 1, wherein the shafts are longitudinally arranged inside the casing in parallel in two rows.

6. The projection screen as claimed in claim 1, wherein the number of the openings is two, and the position of each of the screens corresponds to one of the openings.

7. The projection screen as claimed in claim 1, wherein the opening is disposed at the bottom of the casing and located between the shafts, and the position of each of the screens is disposed corresponding to the opening.
